(19) United States
(12) Patent Application Publication
(10) Pub. No.: US 2003/0236983 A1
(43) Pub. Date: Dec. 25, 2003

(54) Secure data transfer in mobile terminals and methods therefor

(76) Inventor: Thomas J. Mihm JR., Crystal Lake, IL (US)

Correspondence Address: MOTOROLA INC, 600 NORTH US HIGHWAY 45, LIBERTYVILLE, IL, 60048-5343, US

(21) Appl. No.: 10/177,338

(22) Filed: Jun. 21, 2002

(51) Int. Cl. H04L 9/00

(52) U.S. Cl. 713/172

(57) ABSTRACT

Handheld electronics devices, for example wireless subscriber units and smart cards, including a unique identification number (152) stored in the non-rewriteable memory (150), an encrypted unique identification number (162) stored in the non-volatile memory (160), the encrypted unique identification number is the unique identification number encrypted by a master encryption key. Methods for making, initializing and securely communicating with these devices are also disclosed.

### FIELD OF THE INVENTIONS

The present inventions relate generally to secure communications, and more particularly to secure communications devices, methods for manufacturing secure communications devices, and methods for communicating with secure communications devices, for example cellular handsets, smart cards, etc.

### BACKGROUND OF THE INVENTIONS

Sustained growth in the e-commerce sectors of the economy depends substantially on the ability to communicate electronic information securely. Wireless networks, for example, hold vast potential for future commercial growth, provided information can be transferred over-the-air securely, without being intercepted and/or copied by unintended recipients. Security is also required for communications between other interfaces and over other networks, for example in smart-card transactions. Secure devices, methods for making secure devices, and methods for securely communicating information with secure devices are required to satisfy these needs.

The procedures and processes characteristic of the manufacture and operation of many electronics devices, for example wireless communications devices and smart cards, and the corresponding security concerns associated therewith are not served well by existing security solutions.

The various aspects, features and advantages of the present inventions will become more fully apparent to those having ordinary skill in the art upon careful consideration of the following Detailed Description of the Invention with the accompanying drawings described below.

### BRIEF DESCRIPTION OF THE DRAWINGS

FIG. 1 is a block diagram of an exemplary electronics device on which an encrypted unique identification code is stored.

FIG. 2 is an exemplary key data distribution process diagram.

FIG. 3 is an exemplary initialization key and password generating process.

FIG. 4 is an exemplary password and encryption process.

FIG. 5 is an exemplary password double encryption process.

FIG. 6 illustrates exemplary password and encrypted password combining and encryption processes.

FIG. 7 is an exemplary password verification and encrypted unique electronics device ID storage process.

FIG. 8 is an exemplary decryption process on an electronics device.

FIG. 9 is another exemplary decryption process on an electronics device.

FIG. 10 is an exemplary encrypted data transfer process.

FIG. 11 illustrates exemplary decryption processes.

FIG. 12 is an exemplary encryption process on an electronics device.

FIG. 13 is an exemplary decryption process on a process control server.

FIG. 14 is another exemplary decryption process on a process control server.

FIG. 15 illustrates exemplary random value generation processes.

FIG. 16 illustrates exemplary software encryption key generation processes.

FIG. 17 illustrates exemplary encrypted software transfer and decryption processes.

FIG. 18 illustrates exemplary decryption processes.

FIG. 19 illustrates exemplary random number transfer key synthesis processes.

FIG. 20 illustrates an exemplary random number transfer key synthesis process on a subscriber unit.

FIG. 21 illustrates an exemplary random number transfer key synthesis process at a service provider.

FIG. 22 illustrates an exemplary random number encryption process.

### DETAILED DESCRIPTION OF THE INVENTIONS

The invention relates to secure devices, processes for manufacturing secure devices, and methods for using secure devices. In the present invention, some operations are performed in secured environments and other operations are performed in relatively unsecured environments. The invention also pertains to methods for secure communications using secured devices.

The exemplary electronics devices discussed herein are mobile wireless communications devices, for example a cellular telephone handsets, or a two-way pager handsets, or a wireless enabled personal digital assistants (PDAs), or other wireless communications enabled portable devices, for example wireless enable laptop computers. The electronics devices may also be smart cards or other smart devices.

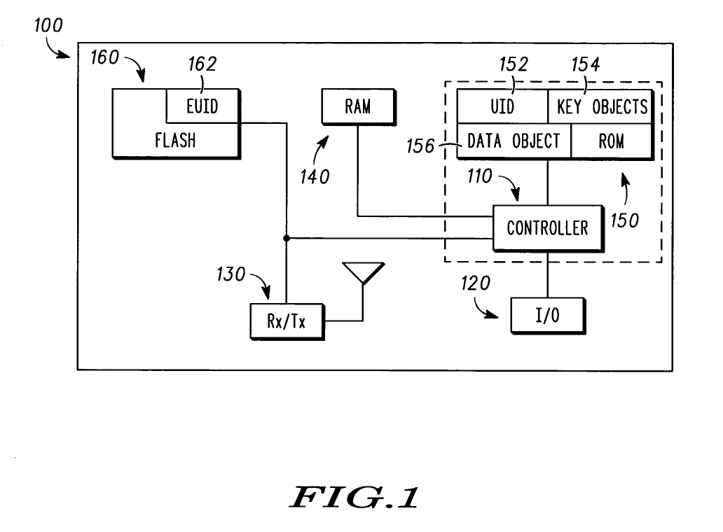

In FIG. 1, the mobile wireless communications device 100 comprises generally a controller 110, for example a central processing unit (CPU) and in some embodiments a digital signal processor (DSP), which is not illustrated. The controller is coupled to input/output (I/O) devices 120, for example a keypad, a display, data ports, audio inputs/outputs, etc., which are typical of such devices. In the exemplary embodiment, the controller is also coupled to a transceiver 130 and to memory, including random access memory (RAM) 140, read-only memory (ROM) 150, and in some embodiments Flash ROM 160.

In FIG. 1, ROM 150 is a non-rewriteable memory and flash ROM 160 is a rewriteable non-volatile memory (NVM) both of which may be integrated on the electronics device, for example as part of an application specific integrated circuit (ASIC). Alternatively, the ROM 150 and Flash ROM 160 may be discrete components mounted on a circuit board. In other embodiments, the ROM 150 and the flash ROM 160 may be disposed on a removable device having an electronics interface for use with some other device. In a preferred embodiment, the ROM 150 is integrated on the same chip as the controller. The ROM 150 and RAM 140 are preferably couple to the controller by separate buses.

In other embodiments, the integrated non-rewriteable memory 150 and the rewriteable non-volatile memory 160 constitute part of a smart card, for example a credit card or some other smart device. Smart cards and other smart devices do not necessarily include all of the elements illustrated in FIG. 1, for example the transceiver 130 and some inputs and outputs, for example the keypad, typical of wireless communication devices will not be included in smart devices. The cellular handsets, smart cards and other devices in which the invention is embodied are referred to herein collectively as electronics devices or as mobile devices.

In one embodiment, a unique identification number (UID) 152 is stored on the integrated non-rewriteable memory. The UID is a representation of alphabetic characters and/or numerals or other symbols. The UID may be hard-coded in or on a ROM device, for example by laser etching. In other embodiments, the UID is a randomly generated number written to a limited access portion of memory, also stored on the ROM. In one embodiment, the UID is accessible only by micro-code stored in memory, for example in the ROM, for limited use, for example, to encrypt the UID and for subsequent authentication, as discussed more fully below. The micro-code is also referred to herein as UID reading firmware or ROM firmware or firmware or an initialization program. Preferably, the UID is inaccessible to users, except possibly by tampering.

The UID is preferably stored in a ROM that is integrated with the controller, as discussed above, so that the controller is able to read the UID from ROM without making the contents of the ROM accessible on an external data bus.

In one embodiment, in FIG. 1, an encrypted unique identification number (EUID) 162 is stored on the rewriteable non-volatile memory 160. The EUID 162 is formed by encrypting the UID 152, for example with a master encryption key as discussed more fully below. In some applications, the UID 152 is encrypted by a service provider, for example during an initialization process, whereupon the service providers sends the encrypted UID (EUID) 162 to the device for storage in memory, for example in non-volatile memory.

After the UID on the electronics device has been encrypted, for example by the exemplary initialization process discussed below, the electronics device is capable of secure communications and transactions. In cellular applications, for example, a service provider may use the UID of a particular cellular or wireless subscriber to generate an encryption key used to encrypt data sent to the subscriber, wherein only the cellular subscriber having the UID will be able to decrypt the encrypted data. Also, since the service provider controls the encryption of the UID, the service provider has some control over the cellular subscriber, for example the subscriber can't change or use another service provider without permission of the original service provider. More generally, the EUID 162 may be used to secure communications with the service provider or some other entity, for example by authenticating the user or the device and/or another party to the transaction.

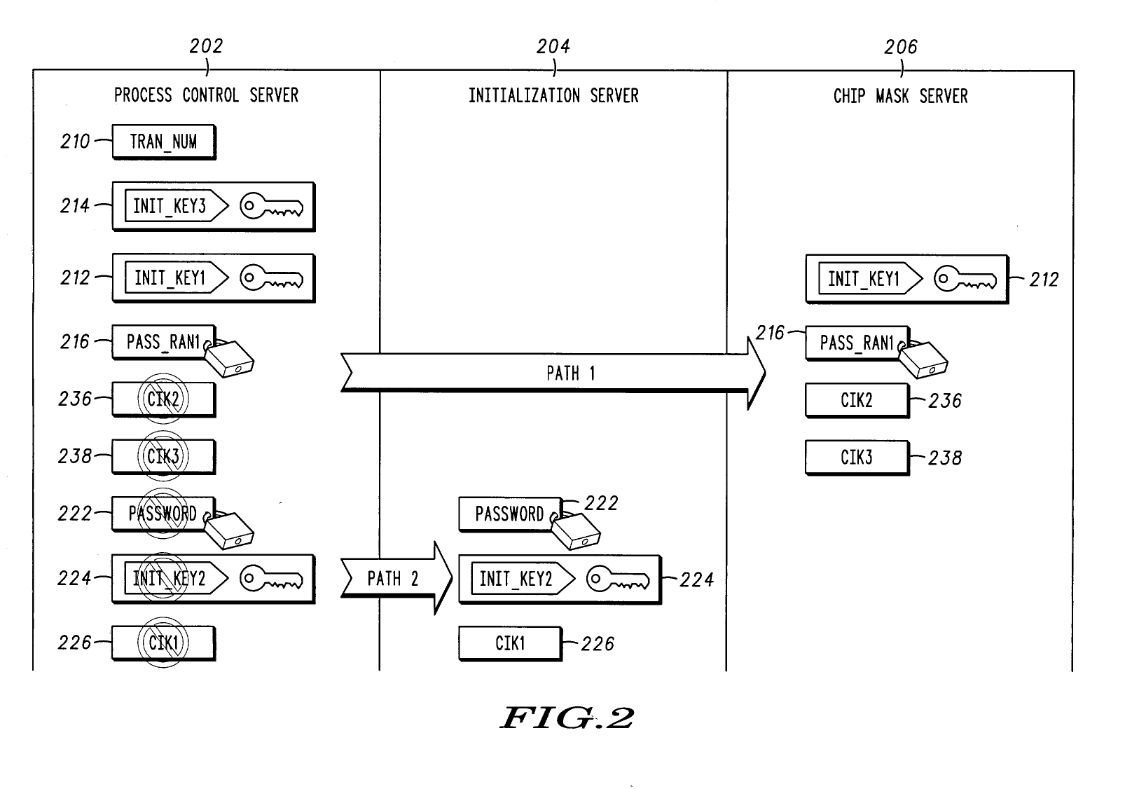

In FIG. 2, in one exemplary embodiment, a process/control server 202, for example a wireless service provider or a financial institution, distributes key data to an initialization server 204 and to a chip mask server 206, all of which are preferably located in different geographical areas. On the process/control server 202, resides a reference number (Tran_Num) 210, which is preferably unique, a first key object 212, a third key object 214, and an encrypted data object (Pass_Ran1) 216.

An initialization server 204, for example a device manufacturer, includes a doubly encrypted password 222, a second key object 224, and a first crypto ignition key (CIK1) 226, which are transferred from the process/control server 202 in the exemplary embodiment. A chip mask server 206, includes the first key object 212, the encrypted data object (Pass_Ran1) 216, a second crypto ignition key (CIK2) 236, and a third crypto ignition key (CIK3) 238, which are also transferred from the process/control server 202 in the exemplary embodiment. In the exemplary embodiment, the first, second and third key objects are split encryption key objects, the generation of which is discussed further below.

In FIG. 2, the two separate paths, path 1 and path 2, are preferably used to distribute the key data from the process/control server 202 to chip mask server 206 and to the initialization server 204, thus making interception and reconstruction by unauthorized parties difficult. In other embodiments, the key data may be distributed by some other source. Once all of the key data has been distributed and each recipient has confirmed receipt of the key data, all three crypto ignition keys 226, 236, and 238, the double encrypted Password 222, and the second key object 224 are destroyed at the process/control server 202. Upon destroying these key data at the process/control server, compromise requires obtaining information from at least two sites, which are preferably separated geographically.

The key data sent to the chip mask server 206 is embedded into mask ROM integrated circuits, for example in a batch process, along with the micro-code or firmware capable of accessing and using the key data. Thus each ROM integrated circuit run that has a new mask will have encryption key parameters.

In FIG. 1, for example, a key object 154 and a data object 156 are stored on the integrated memory device 150 along with the UID 152. In the exemplary embodiment, the key objects are the first key object (Init_Key1) 212, (CIK2) 236, (CIK3) 238 and the data object is the encrypted data object (Pass_Ran1) 216 of FIG. 2. The first key object 154 and the data object 156 are used to encrypt the UID, as discussed further below. In some embodiments, the process/control server 202 and the initialization server 204 store key data in a database indexed and associated with a particular IC/phone/customer production run.

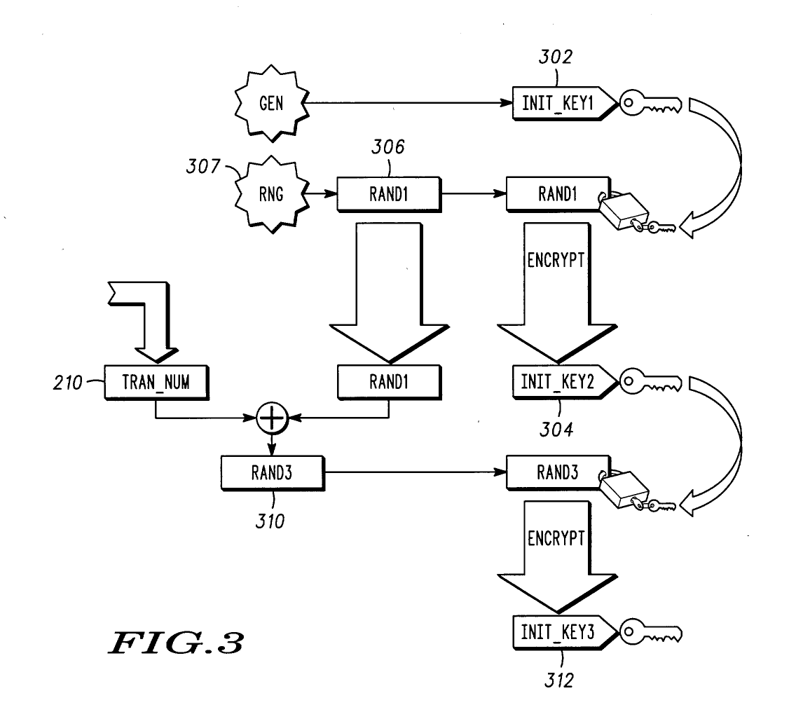

In one exemplary embodiment, the key data of FIG. 2 is generated as discussed below in connection with FIGS. 2-5, although in other embodiments the key data may be generated by alternative schemes. In FIG. 3, at the process/control server, three keys are generated. A first key (Init_Key1) 302 is generated using key generation techniques known to those skilled in the art. A second key (Init_Key2) 304 is derived from the first key (Init_Key1), for example by encrypting a random number Rand1 306 produced by a random number generator (RNG) 307. The unique number (Tran_Num) 210 is combined with Rand1, for example through an exclusive OR-ing process, to form Rand3 310. A third key (Init_Key3) 312 is derived from the second key (Init_Key2) 304 by encrypting Rand3. After generation of the first, second and third keys 302, 304 and 312, Rand3 310 may be destroyed.

In one embodiment, the unique number (Tran_Num) 210 is used to associate the key generation process with a phone/IC initialization process, discussed below, thus providing protection against a substitution and replay attack.

The first, second and third keys 302, 304 and 312, also referred herein to as initialization keys, are each split by combining each of the keys with a corresponding crypto ignition key, for example through an exclusive OR-ing process, to form the first, second and third key objects 212, 224 and 214. Once all three initialization keys have been split, the third key 312 may be destroyed.

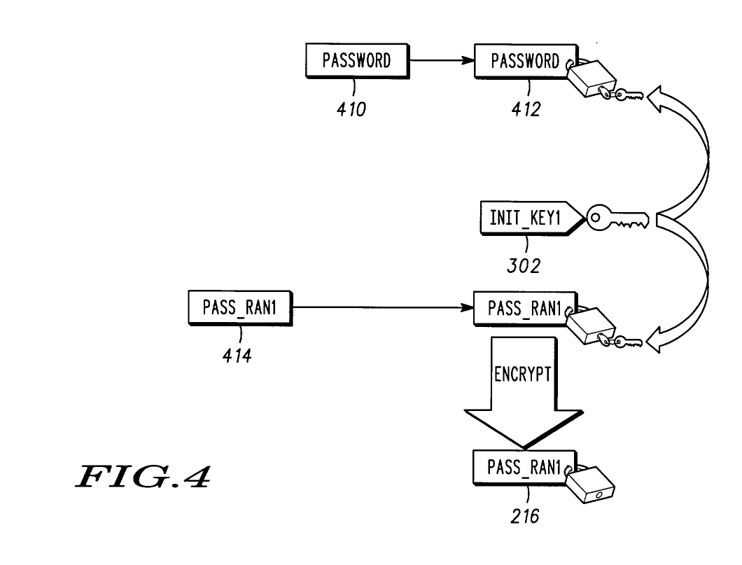

In FIG. 4, a randomly generated password 410, which is preferably unique, is encrypted using the first key 302 to form an encrypted password 412. The encrypted data object (Pass_Ran1) 216 is generated by encrypting Pass_Ran1 414 with the first key 302. The password 410 may be generated using techniques known to those of ordinary skill in the art. Pass_Ran1 414 is generated, for example, by concatenating Rand1 306 with password 410.

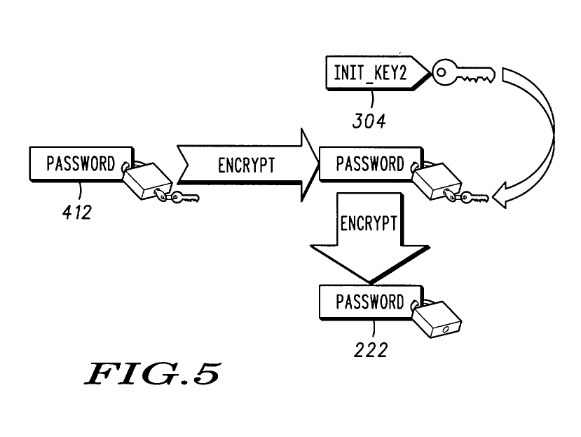

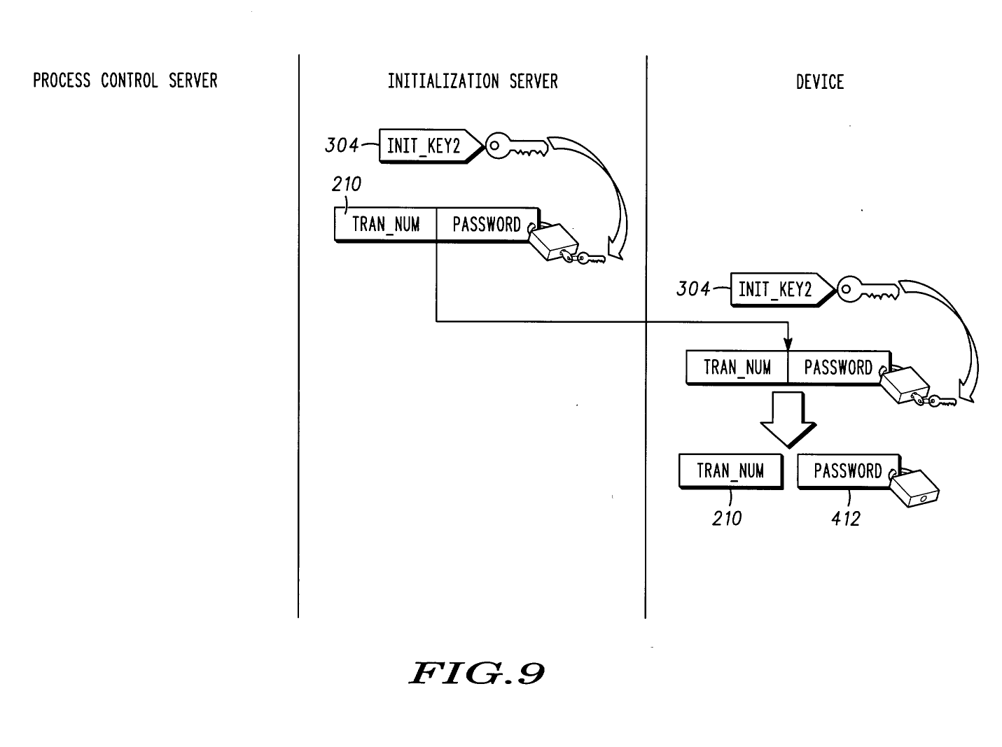

In FIG. 5, the encrypted password 412 is encrypted again using the second key (Init_Key1) 304, thus forming the doubly encrypted password 222. Thereafter, Rand1 306, Password 410, Pass_Ran1 414, the first Key (Init_Key1) 302, and the second key (Init_Key2) 304 may all be destroyed. In some applications, the electronics device is provided with the appropriate key to decrypt the doubly encrypted password as discussed further below in connection with FIG. 9.

In FIG. 1, according to the exemplary process of FIGS. 3-5, the first key object 154 in ROM 150 comprises, in part, the combination of the first key (Init_Key1) 302 and the first crypto ignition key (CIK1) 226, as discussed above. The data object 156 in ROM 150 comprises a first random number combined, for example by concatenation, with a password, wherein the combined first random number and password are encrypted by the first key (Init_Key1) 302, as discussed above. In other embodiments, the first key object and the data object stored in ROM 150 may be generated by alternative means.

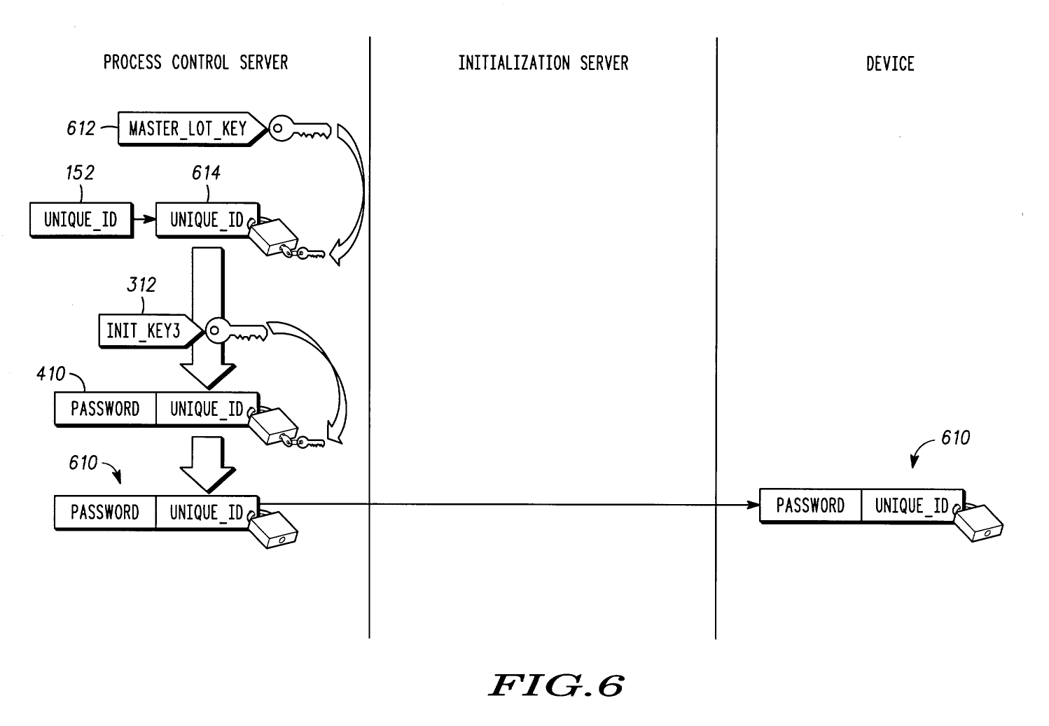

In one embodiment, the UID stored in ROM on the electronics device, which is a wireless subscriber handset in the exemplary embodiment, is transmitted or otherwise communicated by the device to the process control server, for example a service provider, which performs the encryption. In FIG. 6, the UID 152 received from the device is encrypted with a unique secret key (Master_Lot_Key) 612 to form an encrypted Unique_ID 614. The encrypted Unique_ID 614 is combined with a password 410. The encrypted Unique_ID and password may be combined by concatenation or by other means. The same unique secret key (Master_Lot_Key) 612 may be used later by the service provider to recover the Unique_ID in encrypted form received from the electronics device when service is requested, for authentication purposes as discussed below. The encrypted Unique_ID 614 and password 410 combination is subsequently encrypted with the third key (Init_Key3) 312 to form an encrypted combination (Unique_ID/Password) 610 that is then sent to the electronics device.

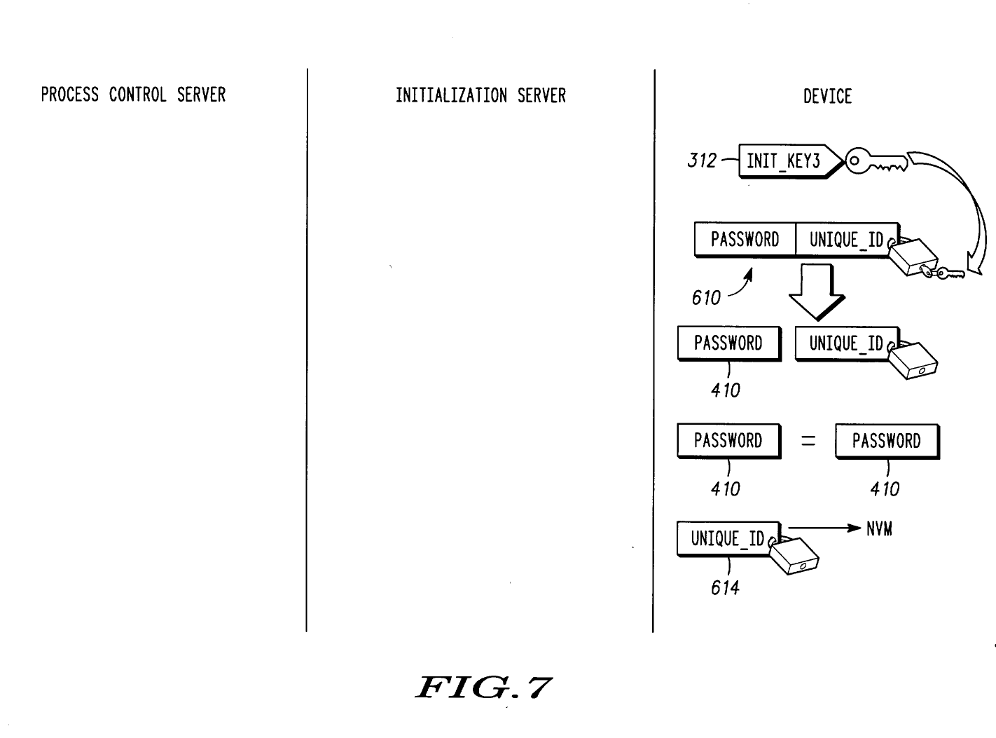

In FIG. 7, upon receipt of the encrypted combination (Unique_ID/Password) 610 by the electronics device, the ROM initialization program uses the third key (Init_Key3) 312 to decrypt the encrypted combination (Unique_ID/Password) 610. After decrypting the password 410 from the encrypted combination (Unique_ID/Password) 610, the integrity of the process is checked by comparing the password 410 to password 410 stored previously on the device. If they are equal, or match, the ROM initialization program stores the encrypted unique identity (Unique_ID ) 614 in non-volatile memory (NVM). At this point, the device has been initialized to the service provider's unique secret key (Master_Lot_key) 612 and is ready to receive encrypted downloads or perform other secure communications, depending on the nature of the electronics device.

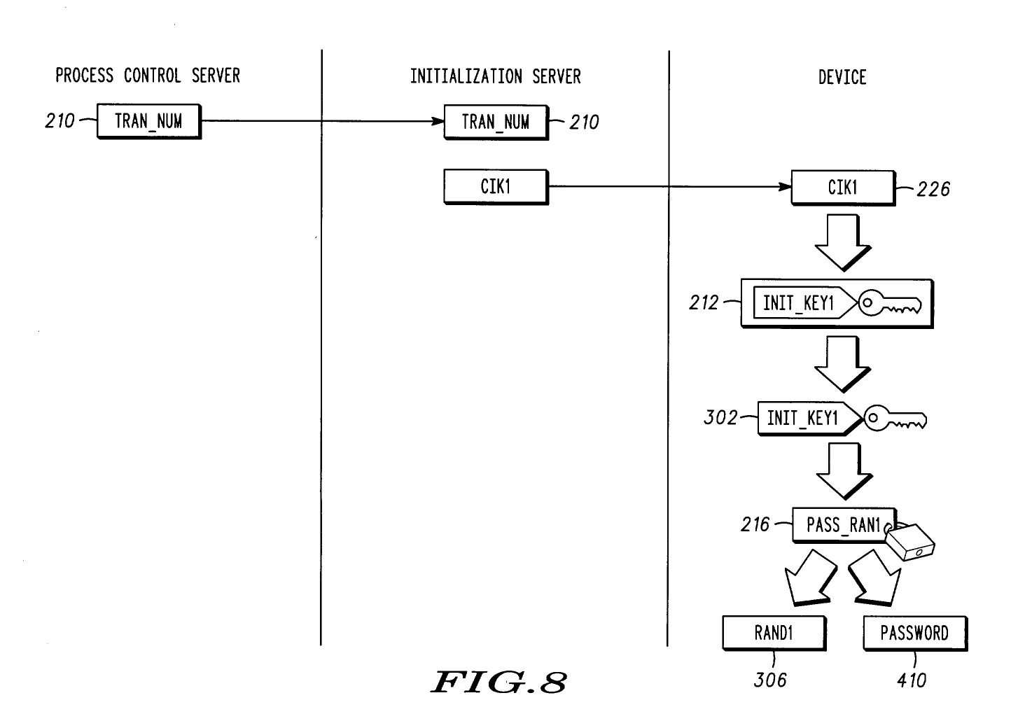

In one embodiment, the reference password 410 is stored on the electronics device as follows. In FIG. 8, the ROM initialization program recovers the first key (Init_Key1) 302 from the first key object 212 using the first crypto ignition key (CIK1) 226, which were received from the initialization server or some other source and stored on the device previously, as discussed above. The ROM initialization program decrypts the encrypted data object (Pass_Ran1) 216 with the first key (Init_Key1) 302 to recover the first random number (Rand1 ) 306 and the password 410, which was used above in the process of FIG. 7 to authenticate the encrypted UID (EUID) 614 received from the service provider by comparison with the password 410 recovered with the encrypted UID.

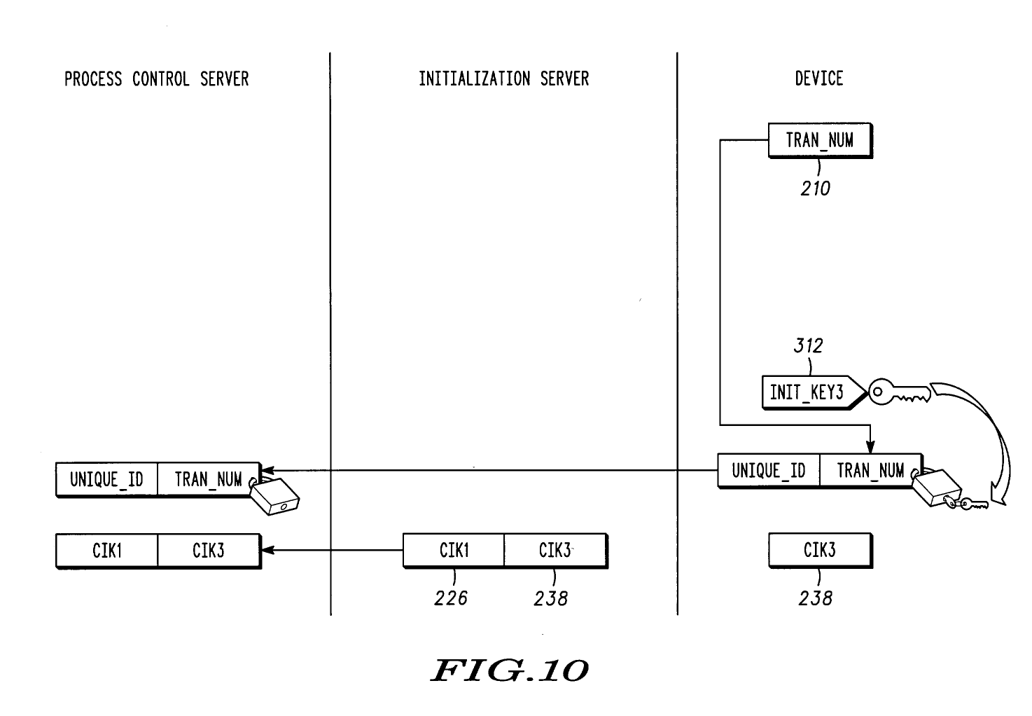

An exemplary scheme for transferring the UID from the device to the processs/control server, for example to a service provider to permit encryption of the UID as discussed in connection with FIGS. 6-8, is discussed below with reference to FIGS. 9 and 10. In FIG. 9, at the electronics device, the ROM initialization program uses the second key (Init_Key2) 304 to decrypt and recover the unique number (Tran_Num) 210 and an encrypted password 412, which were previously combined for example, by concatenation, and encrypted with the second key 304 at the initialization server prior to transmission to the electronics device. The unique number (Tran_Num) 210 was provided previously to the initialization server by the process/control server, as illustrated in FIG. 8. The device checks the integrity of the process by decrypting the encrypted password 412 using the first Key (Init_Key1) obtained previously in FIG. 8 to recover the unencrypted password 410 and comparing the password 410 received from the Initialization Server with the password 410 recovered from the data object (Pass_Ran1) 216 as shown in FIG. 8.

In FIG. 10, if the password 410 received from the Initialization Server is equal to or the same as the password 410 recovered from the data object (Pass_Ran1) 216 as shown in FIG. 8, the ROM initialization program combines, for example by concatenation, the unique number (Tran_Num) 210 with the UID stored on the device, and then encrypts the combination using the third key (Init_Key3) 312. The device then sends the encrypted combination to the process/control server and sends the third crypto ignition key (CIK3) 238 to the initialization server. In FIG. 10, the first and third crypto ignition keys 226 and 238 are combined, for example by concatenation, at the initialization server and sent to the process/control server. The process/control server may thus use the unique number (Tran_Num) 210 received from the device to authenticate the UID received from the device by comparison with the unique number (Tran_Num) 210 distributed initially in FIG. 2, as discussed further below.

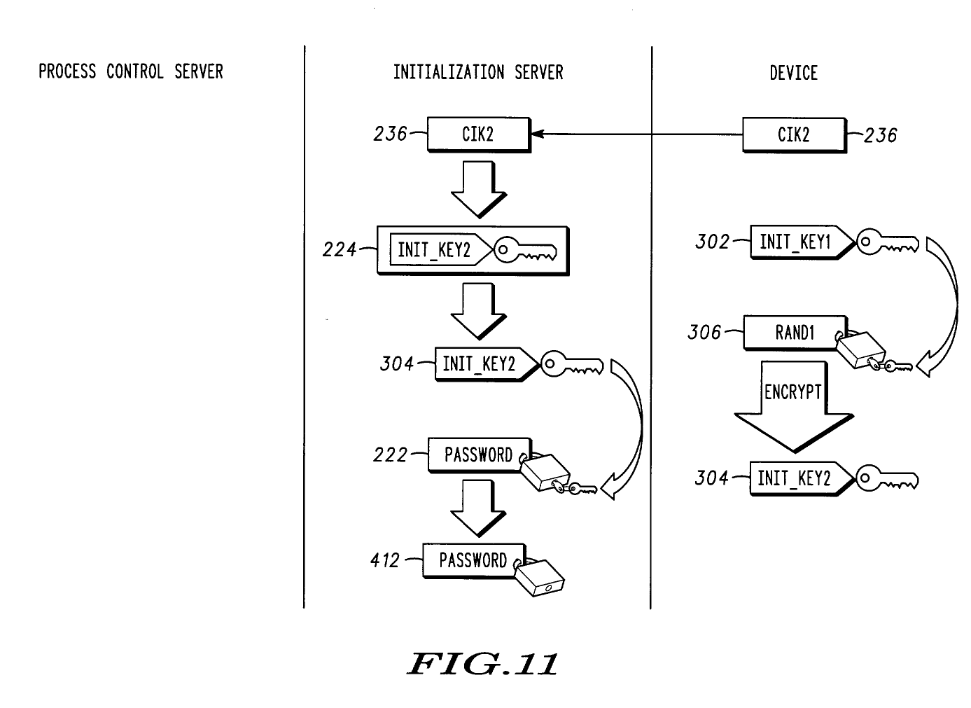

In one embodiment, the initialization server obtains the encrypted password 412 by using a crypto ignition key obtained from the electronics device. In FIG. 11, at the electronics device, the ROM initialization program derives the second key 304 by encrypting Rand1 306 with the first key 302. The ROM initialization program also sends the second crypto ignition key (CIK2) 236 to the initialization server. At the initialization server, the second crypto ignition key (CIK2) 236 recovers the second key (Init_Key2) 304 from the second key object 224. The second key (Init_Key2) 304 is then used to remove the first layer of encryption from the doubly encrypted password 222, thus producing the encrypted password 412, which is combined with the unique number (Tran_Num) 210 and sent to the device as discussed above in FIG. 9.

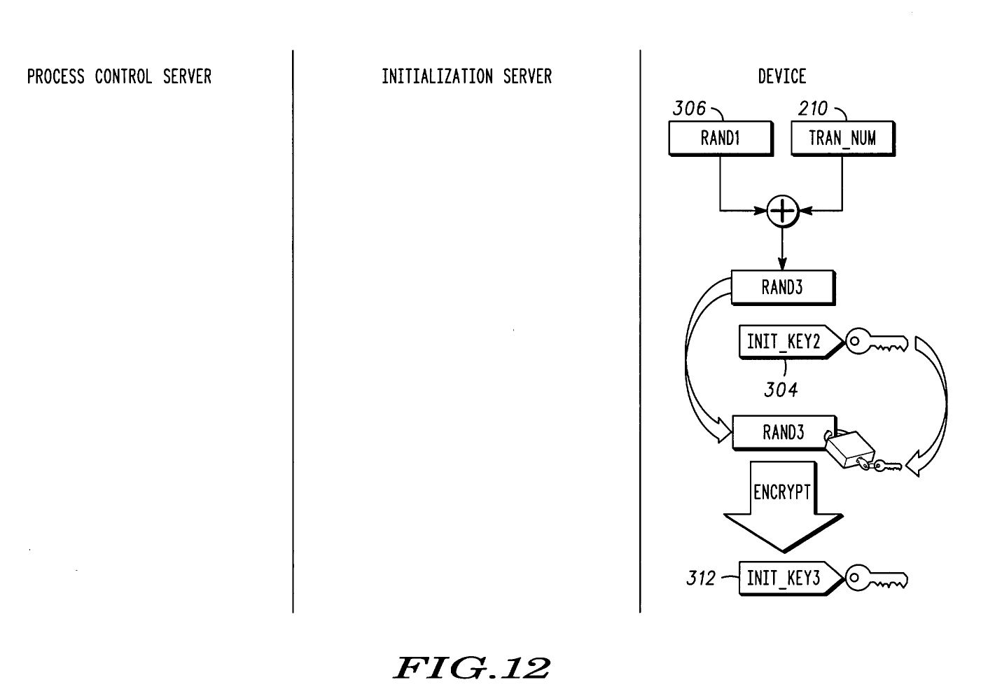

In FIG. 12, the ROM initialization program derives the third key (Init_Key3) 312 by encrypting a third random number (Rand3 ) with the second key (Init_Key2) 304. In one embodiment, the third random number (Rand3 ) is derived by exclusive OR-ing the first random number (Rand1 ) 306 and the unique number (Tran_Num) 210, although it may be generated by alternative schemes.

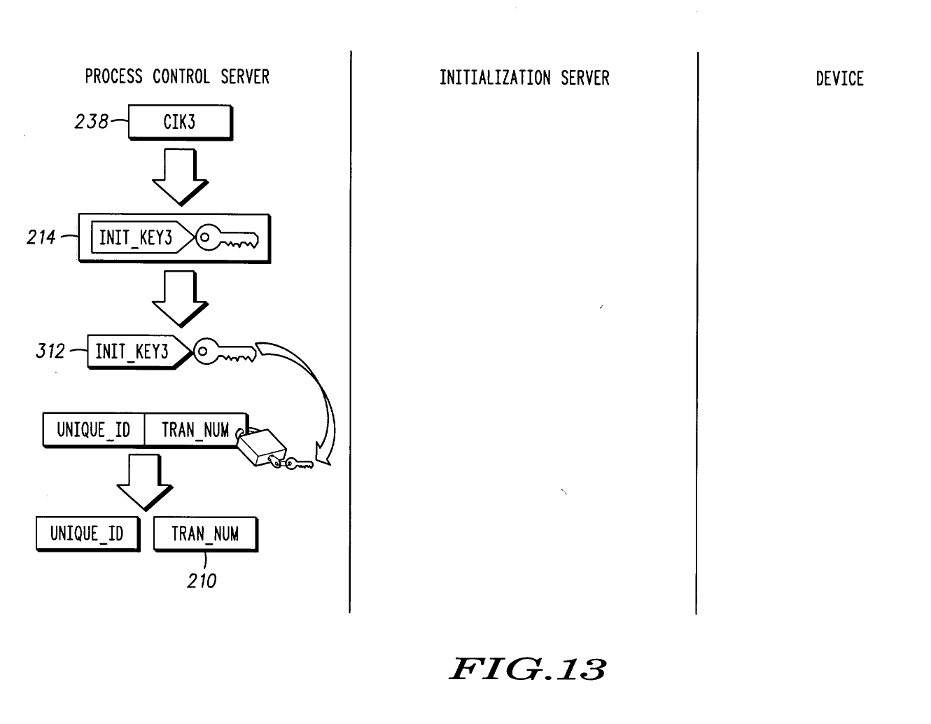

In FIG. 13, the server recovers the third key (Init_Key3) 312 from the third key object 214 using the third crypto ignition key (CIK3) 238 received from the electronics device via the initialization server as discussed above in connection with FIG. 10. The process/control server uses the third key (Init_Key3) 312 to decrypt the encrypted combination of the UID (IC Unique_ID) and the reference number (Tran_Num) 210 received from the electronics device, as discussed above in connection with FIG. 10.

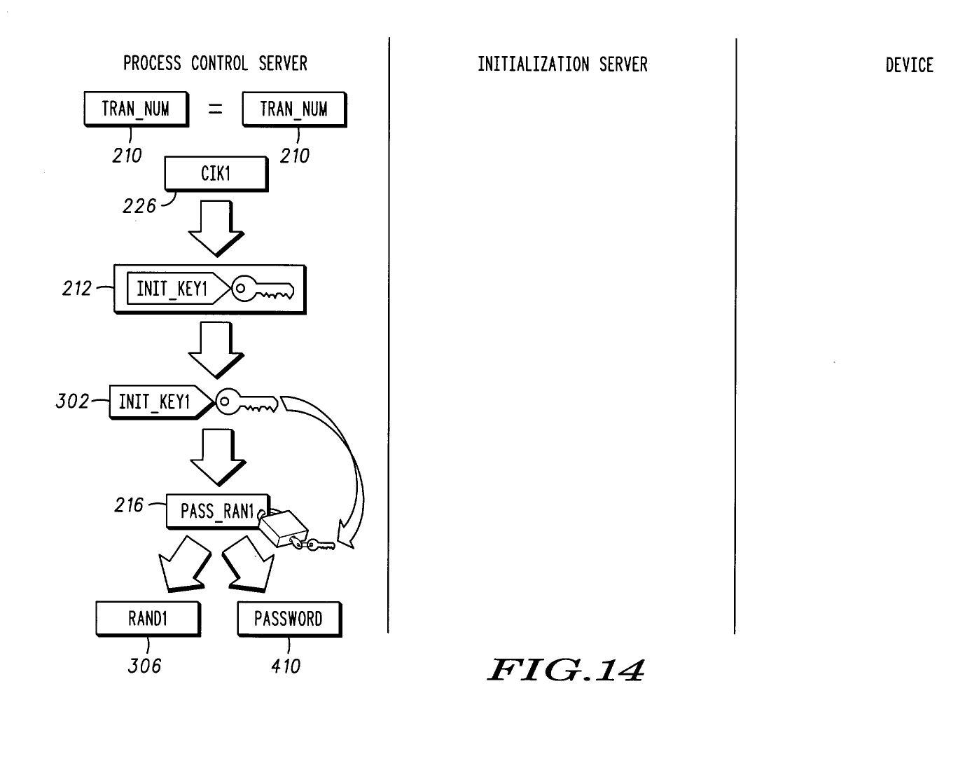

In FIG. 14, the process/control server checks the integrity of the process by comparing the unique number (Tran_Num) 210 received from the device with the unique number (Tran_Num) 210 stored originally, as discussed above in connection with the key data distribution of FIG. 2. If the values are equal the process/control server uses the first crypto ignition key (CIK1 ) 226 to recover the first key (Init_Key1) 302 from the first key object 212. The first random number (Rand1 ) 306 and the password 410 are recovered from the encrypted data object (Pass_Ran1) 216 using the first key 302.

Security may be enhanced by storing the encrypted copy of the UID on a SIM or UIM. In wireless communications devices, the initialization process just described may be carried out over-the-air by the user as a phone registration process, since the protocol described does not require that the phone be in a secure environment. The initialization may also be performed over a wire-line network. Since not all phones require a SIM, a preferred implementation is to store the encrypted copy of the UID in non-volatile memory (NVM).

As discussed above, the electronics device contains an unencrypted read-only copy of the UID that was stored in the ROM at the time of the integrated circuit fabrication. A copy of the UID has also been encrypted with a master key (Master_Lot_Key) 612 of the service provider and stored in NVM of the device. The unencrypted UID stored in ROM is read accessible only by firmware located in ROM. The unencrypted UID stored in ROM can never be transmitted or otherwise accessed, except by the firmware. Therefore it is not possible to clone the device simply by intercepting communications, for example by “listening” to the over-the-air transactions. Upon encrypting the UID of the electronic device, the device may be used for secure communications and to securely transfer information.

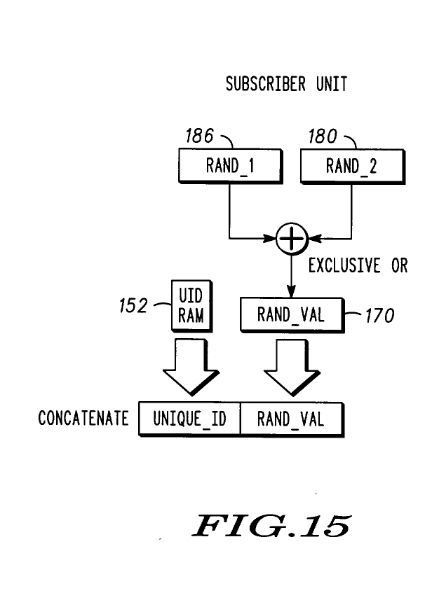

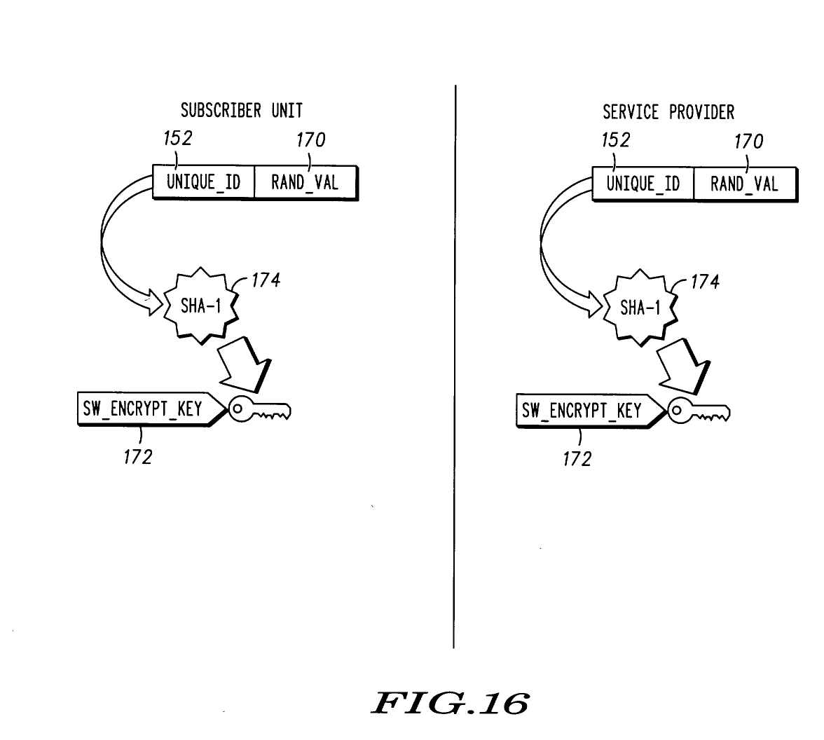

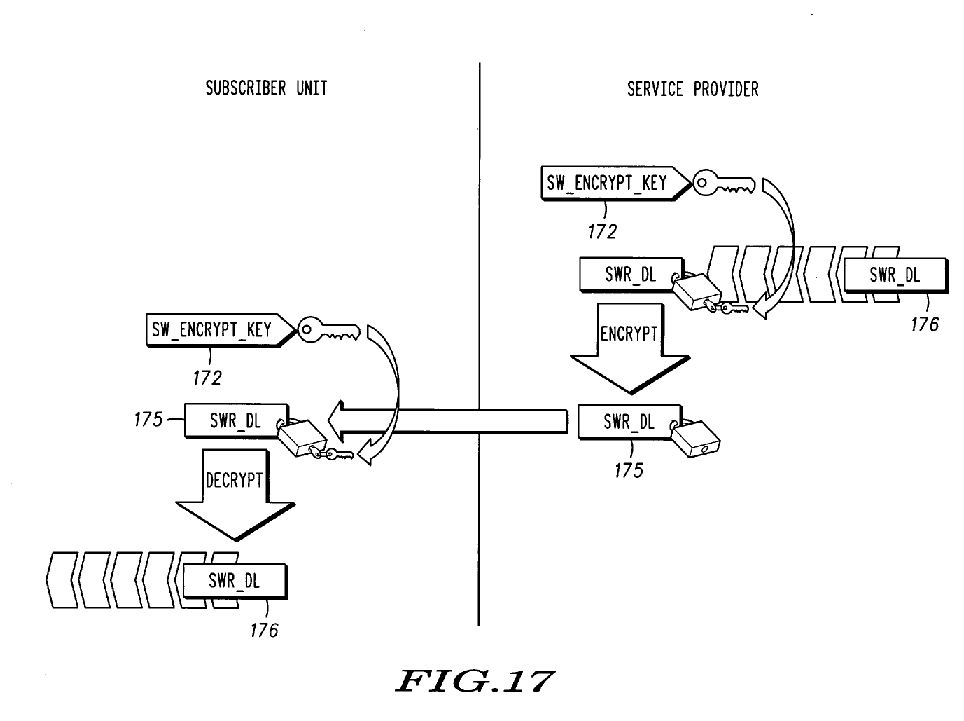

An exemplary data transfer from a service provider to a wireless communications subscriber unit having an encrypted UID is discussed below. In FIG. 15, at a wireless subscriber unit, the UID 152 stored in ROM is combine, for example by concatenation, with a random value (Rand_Val) 170. The same process occurs at the server. In FIG. 16, the combination of the UID 152 and random value 170 is used to synthesize a transport key (SW_Encrypt_Key) 172 using a hash algorithm 174. The service provider also generates the transport key 172 by a similar process, as illustrated in FIG. 16. In FIG. 17, data, for example software (SWR_DL) 175, encrypted with the transport key 172 by the service provider is transferred to and received by the wireless subscriber unit, where the software 176 may be recovered by decrypting the encrypted software with the transport key 172 generated at the wireless subscriber unit.

The service provider controls the master key (Master_Lot_Key) 612 and the security associated with it. Protecting the master key is made more manageable by requiring that it be stored only in a single location and never requiring that the master key (Master_Lot_Key) be transmitted. This minimizes the risk of compromise. It is the responsibility of the service provider to protect the master key using techniques known by those having ordinary skill in the art.

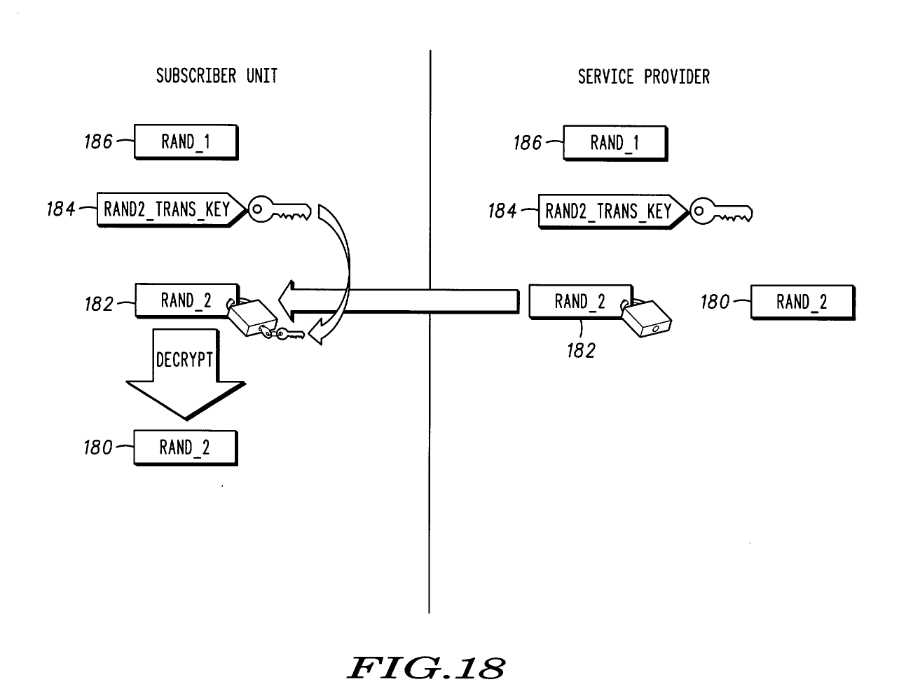

In FIG. 15, the random value 170 is generated at both the service provider and wireless subscriber unit by combining a first random number 186 and a second random number 180, for example in an exclusive OR-ing process. In FIG. 18, the second random number (Rand_{—}2) 180 is encrypted at the service provider with a transfer key (Rand2_Trans_key) 184 to generate an encrypted second random number 182, which is transferred to the subscriber unit. At the subscriber unit, the second random number 180 is recovered by decrypting the encrypted second random number 182 with the transfer key 184, thus enabling the subscriber unit to generate the same random value 170 as the service provider.

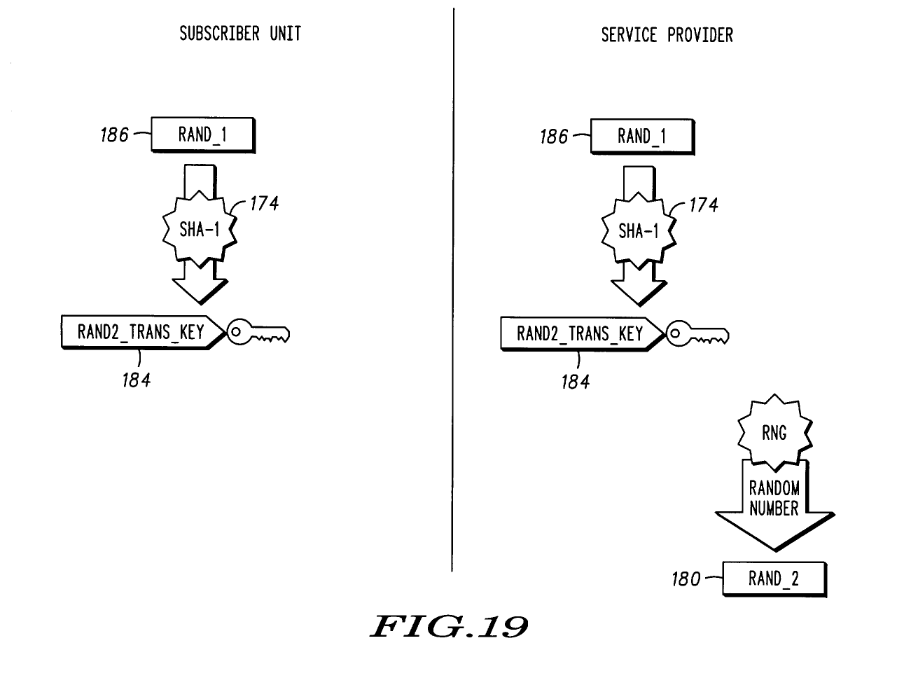

In one embodiment, at FIG. 19, the transfer key 184 is generated, at both the subscriber unit and the service provider, from the first random number (Rand_{—}1) 186 using a hash algorithm 174. The first random number may be generated by any means known to those having ordinary skill in the art, for example with a random number generator. The second random number (Rand_{—}2), discussed above in connection with FIG. 18 may also be generated with a random number generator, as illustrated in FIG. 19.

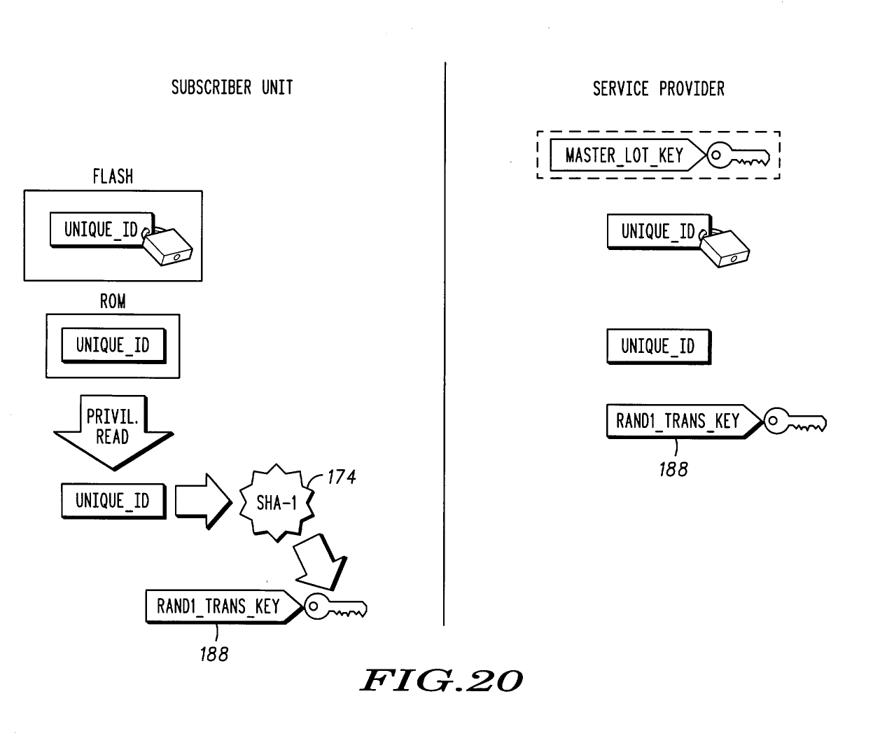

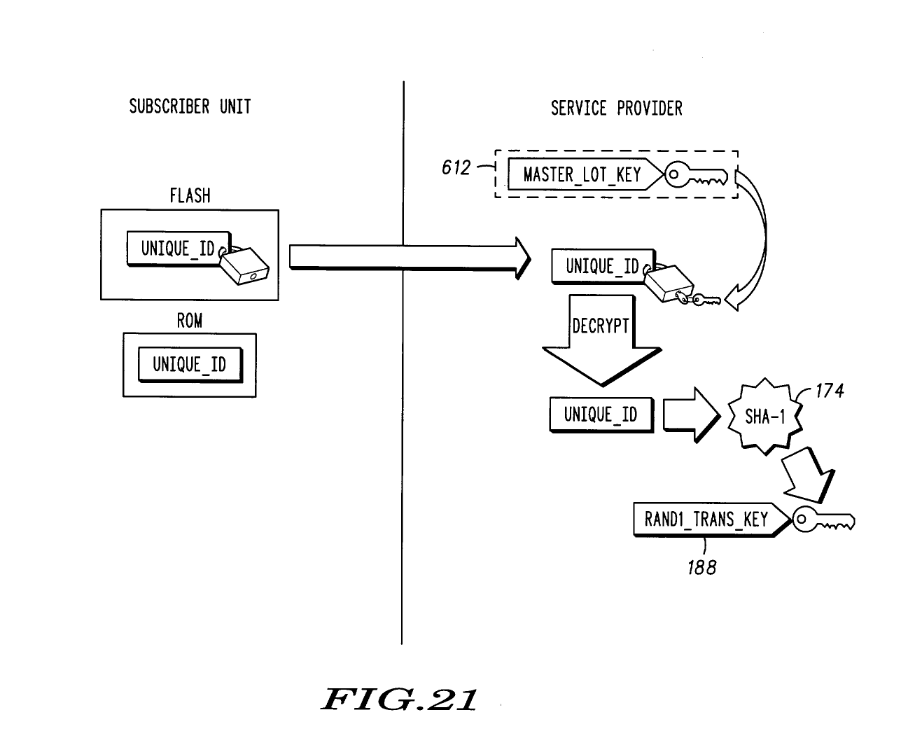

In FIG. 20, at the subscriber unit, the firmware located in ROM reads the unencrypted UID (Unique_ID) from ROM and synthesizes a transfer key (Rand1_Trans_Key) 188 using the SHA1 hashing algorithm 174. In FIG. 21, the service provider recovers the UID (Unique_ID) by decrypting the encrypted UID received from the subscriber unit using the master key 612.

In FIG. 21, the encrypted UID is transmitted to the process/control server, for example a service provider. The service provider recovers the UID by decrypting the encrypted UID from the subscriber unit with the master key (Master_Lot_Key) 612. The transfer key 188 is generated at the service provider by operating on the UID with the hashing algorithm 174.

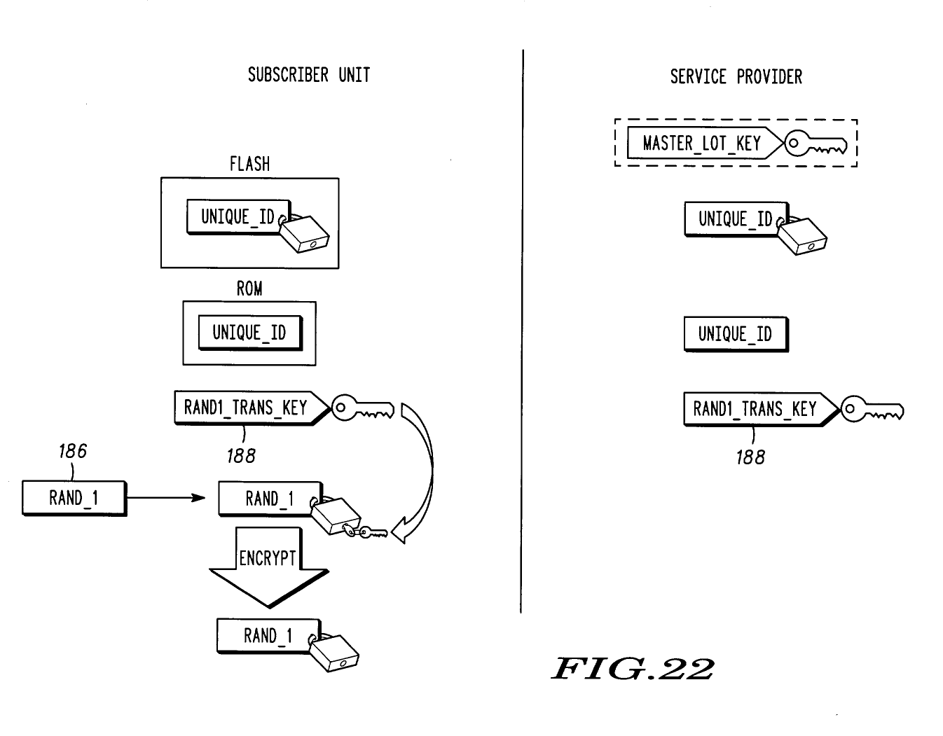

In FIG. 22, the first random number (Rand_{—}1) 186 is encrypted using the transfer key 188 at the subscriber unit. The encrypted first random number is sent to the service provider, which recovers the first random number by decrypting the encrypted random number with the first random number transfer key 188. The first and second random numbers 186 and 180 are used to generate the random value (Rand_VAL) as discussed above in connection with FIG. 15.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. A handheld electronics device, comprising:
a memory device;
a unique identification number stored in the memory device;
a first key object stored in the memory device;
an encrypted data object stored in the memory device.

2. The handheld electronics device of claim 1, the unique identification number stored in a non-rewritable portion of the memory device, unique identification number accessing micro-code stored in the memory device.

3. The handheld electronics device of claim 1, the encrypted data object comprises a first random number combined with a password, the combined first random number and password encrypted by a first key, the first key object comprises the first key combined with a first crypto ignition key.

4. The handheld electronics device of claim 1, at least two different crypto ignition keys stored in the integrated memory device.

5. The handheld electronics device of claim 1 is a mobile wireless communications device comprising a wireless communications transceiver and a processor coupled to the transceiver and to the memory device.

6. The handheld electronics device of claim 1 is a smart card.

7. A handheld electronics device, comprising:
memory including non-rewriteable memory and non-volatile memory;
a unique identification number stored in the non-rewriteable memory;
an encrypted unique identification number stored in the non-volatile memory,
the encrypted unique identification number is the unique identification number encrypted by a master encryption key.

8. The handheld electronics device of claim 7 is a mobile wireless communications device comprising a wireless communications transceiver and a processor coupled to the transceiver, the processor coupled to the non-volatile memory and to the non-rewriteable memory,
unique identification number reading firmware stored in the non-rewriteable memory,
the unique identification number read accessible only by the unique identification number reading firmware.

9. The handheld electronics device of claim 7 is a smart card.

10. A mobile wireless communication device identification encryption method, comprising:
at a mobile wireless communication device, recovering a first password from an encrypted data object stored on the mobile wireless communication device;
at the mobile wireless communication device, receiving an encrypted combination of a second password and an encrypted first unique wireless communication device identification number;
at the wireless communication device, decrypting the encrypted combination of the second password and the encrypted first unique wireless communication device identification number;
storing the encrypted first unique wireless communication device identification number in memory on the mobile wireless communication device if the first and second passwords are the same.

11. The method of claim 10, at the mobile wireless communication device,
recovering a first key from a first key object stored on the mobile wireless communication device;
recovering the first password from the encrypted data object with the first key.

12. The method of claim 11, at the mobile wireless communication device, recovering the first password from the encrypted data object stored on the mobile wireless communication device with a first crypto ignition key received from a first server.

13. The method of claim 10, at the mobile wireless communication device, receiving the encrypted combination of the second password and the encrypted first unique wireless communication device identification number from a server, the encrypted first unique wireless communication device identification number is a unique identification number corresponding to the wireless communication device encrypted with by a master encryption key.

14. A method in a mobile wireless communication device, comprising:
recovering a reference number from an encrypted reference number;
combining the reference number with a first unique wireless communication device identification number stored on the wireless communication device;
encrypting the combined reference number and first unique wireless communication device identification number;
transmitting the encrypted combination of the reference number and the first unique wireless communication device identification number.

15. The method of claim 14, at the mobile wireless communication device,
forming a second key by encrypting a first random number with a first key;
recovering the reference number with the second key.

16. The method of claim 14, at the mobile wireless communication device,
deriving a third key by encrypting a third random number;
encrypting the combined reference number and first unique wireless communication device identification number with the third key.

17. The method of claim 14, at the mobile wireless communication device, receiving an encrypted combination of a password and a second encrypted unique wireless communication device identification number, the second encrypted unique wireless communication device identification number is the first unique wireless communication device identification number encrypted by a master encryption key.

18. A method in a server that communicates with a mobile wireless communication device, comprising:
recovering a second key from a second key object stored on the server;
recovering an encrypted password by partially decrypting a doubly encrypted password with the second key;
combining the reference number with the encrypted password and encrypting the combination of the combined reference number and the encrypted password with the second key;
transmitting the encrypted combination of the reference number and the encrypted password to the mobile wireless communication device.

19. The method of claim 18, receiving a second crypto ignition key from a mobile wireless communication device, recovering the second key from the second key object stored on the first server with the second crypto ignition key.

20. A method in a server that communicates with a mobile wireless communication device, comprising,
receiving an encrypted combination of a reference number and a first unique wireless communication device identification number from a mobile wireless communication device;
decrypting the encrypted combination of the reference number and the first unique wireless communication device identification number with a third key;
authenticating the first unique wireless communication device identification number received from the wireless communication device by comparing the reference number received from the wireless communication device with a reference number at the server.

21. The method of claim 20,
encrypting the first unique wireless communication device identification number with a master key,
combining the encrypted first unique wireless communication device identification number with a first password and encrypting the combination of the encrypted first unique wireless communication device identification number and the first password,
transmitting the encrypted combination of first password and the encrypted first unique wireless communication device identification number to the mobile wireless communication device.

22. The method of claim 21, recovering a first key from a first key object stored on the server, recovering the first password from an encrypted data object stored on the server.

23. A secure data communications method in a mobile wireless communication device, comprising:
combining a random value with a unique wireless communication device identification number stored on the mobile wireless communication device;
at the mobile wireless communication device, forming an decryption key with the combined random value and the unique wireless communication device identification number;
at the mobile wireless communication device, receiving encrypted information and recovering the encrypted information with the decryption key.

24. A secure communication method in a server that communicates with mobile devices, comprising:
receiving an encrypted unique mobile device identification number from a mobile device;
recovering a unique mobile device identification number by decrypting the encrypted unique mobile device identification number with a master key;
authenticating the mobile device with the unique mobile device identification number.

25. A secure communications method in a server that communicates with a mobile device having a unique identification, comprising:
generating an encryption key from a unique identification of a mobile device;
encrypting information with the encryption key;
transmitting the encrypted information to the mobile device having the unique identity from which the encryption key was generated.

26. A method in a server that communicates with a mobile wireless communication device, comprising:
encrypting a first unique wireless communication device identification number received from a mobile wireless device with a master key,
combining the encrypted first unique wireless communication device identification number with a password and encrypting the combination of the encrypted first unique wireless communication device identification number and the password,
transmitting the encrypted combination of the password and the encrypted first unique wireless communication device identification number to the mobile wireless communication device.
